(19) United States
(12) Patent Application Publication
(10) Pub. No.: US 2001/0022915 A1
(43) Pub. Date: Sep. 20, 2001

(54) Support linkage for keyswitch

(76) Inventor: Gino Hu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/865,436

(22) Filed: May 29, 2001

Related U.S. Application Data
(63) Continuation-in-part of application No. 09/108,219, filed on Jul. 1, 1998.

(51) Int. Cl. B41J 5/26

(52) U.S. Cl. 400/472; 400/490

(57) ABSTRACT

A support linkage movably connecting a key cap to a plastic body comprises a first rack and a second rack. The first rack has a first rack body movably connected between the key cap and the plastic body, and the second rack has a second rack body movably connected between the key cap and the plastic body. The second rack body has two axial holes each having an open side and engaged with a shaft on the first rack body.

### FIELD OF THE INVENTION

The present invention relates to a support linkage for keyswitch, more particularly, to a support linkage for keyswitch, which can be easily assembled and is not liable to deform or break during assembling.

### BACKGROUND OF THE INVENTION

The conventional keyset for notebook computer generally comprises a key cap 2, a first rack 1, a second rack 3, a flexible circuit board 4, a resilient body 6, and a base plate 5.

As shown in FIG. 1 and 2, the conventional first rack 1 and second rack 2 are arranged in scissors arrangement. When the key cap 2 is guided by the first rack 1 and the second rack 3 to move upward and downward, whereby the body 6 below the key cap 2 can press on or detach from the flexible circuit board 4 to turn on or turn off the keying.

However, the lateral sides of the rack 1, 3 in conventional art have not sufficient strength such that the racks are liable to deform or break during assembling or detach. Moreover, the assembling of those racks is not easy and requires precise alignment to prevent jamming.

It is the object of the present invention to provide a support linkage for keyswitch, the racks thereof are designed to have easy assembling without the usage of auxiliary tools, and have better strength to prevent the deforming and breaking during assembling or disassemble.

To achieve the above object, the support linkage for keyswitch according to the present invention comprises a first rack and a second rack. The first rack has a first rack body movably connected between the key cap and the plastic body, and the second rack has a second rack body movably connected between the key cap and the plastic body. The second rack body has two axial holes each having an open side and engaged with a shaft on the first rack body.

The various objects and advantages of the present invention will be more readily understood from the following detailed description when read in conjunction with the appended drawing, in which:

### BRIEF DESCRIPTION OF DRAWING

FIG. 1 is the perspective exploded view of the conventional keyset.

FIG. 2 is the perspective view of the scissors-type tack in conventional keyset.

FIG. 3 is a perspective exploded view of the preferred embodiment of the invention.

FIG. 4 is the perspective view of the second rack of the preferred embodiment according to the invention

FIG. 5 is the top view of the second rack of the preferred embodiment according to the invention.

FIG. 6 is the cross section view of the second rack of the preferred embodiment according to the invention.

FIG. 7 is the perspective view of the first rack of the preferred embodiment according to the invention

FIG. 8 is the top view of the first rack of the preferred embodiment according to the invention.

FIG. 9 is the cross section view of the first rack of the preferred embodiment according to the invention.

FIG. 10 is a top view shows the first and second racks of the preferred embodiment according to the invention in scissors arrangement.

FIG. 11 is a perspective view shows the first and second racks of the preferred embodiment according to the invention in scissors arrangement.

FIG. 12 is a view showing the operation of the preferred embodiment according to the invention.

FIG. 13 is another view showing the operation of the preferred embodiment according to the invention.

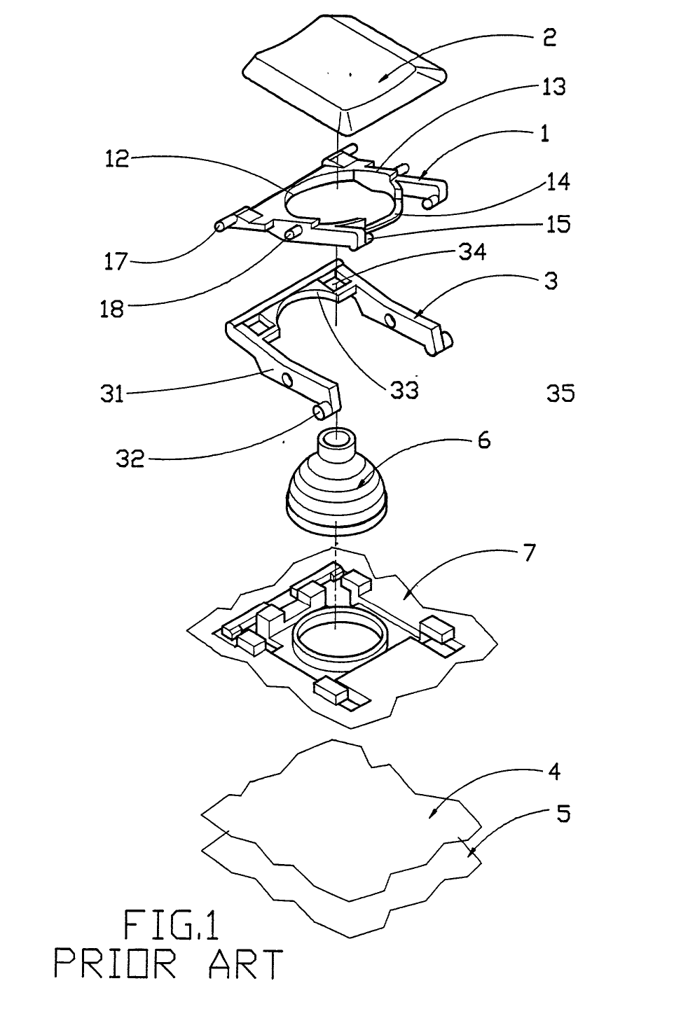

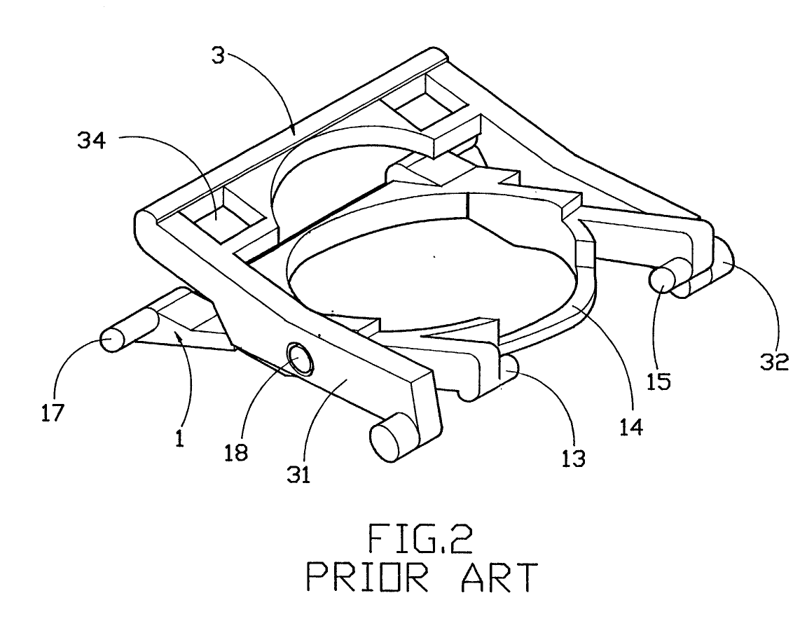

### DETAILED DESCRIPTION OF THE PREFERRED EMBODIMENT

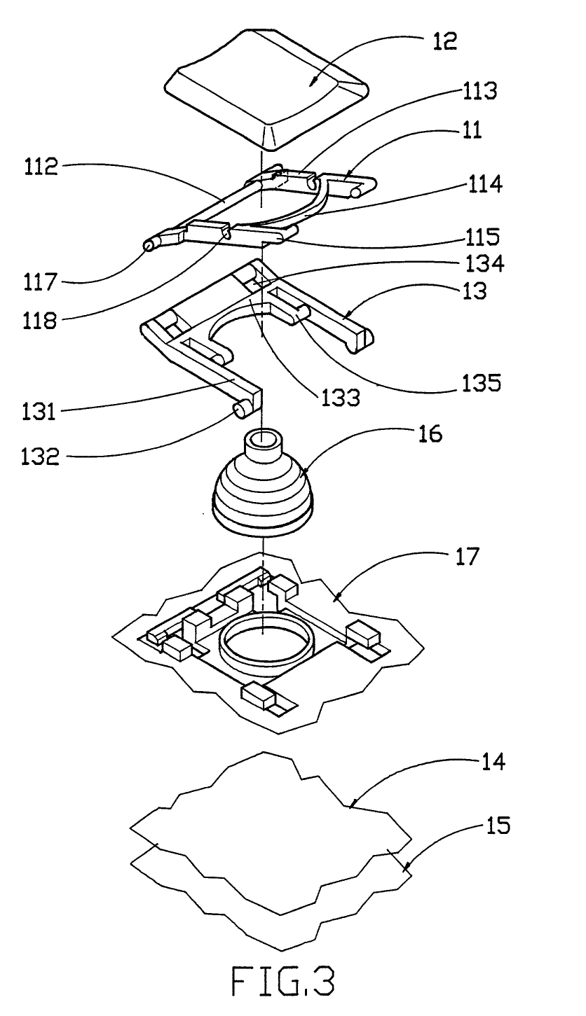

FIG. 3 is a perspective exploded view of the preferred embodiment of the invention. The keyswitch according to the preferred embodiment of the present invention compresses a keycap 12, a first rack 13, a second rack 11, a plastic body 17, a flexible circuit board 14, a resilient body 16 and a base plate 15. The key cap 12 is of rectangular shape and has two embedding part 121 on one upper lateral side within the inner space thereof, and retaining grooves 123 on another side to clamp the first rack 13 and the second rack 11.

The first rack 13 is arranged below the key cap 12 and in scissors arrangement with the second rack 11. The groove 134 of the first rack 13 engages with the embedding part 121 of the key cap 12. The forth shaft 115 of the second rack 11 engages with the retaining groove 123 of the key cap 12.

The plastic body 17 is arranged below the first rack 13 and the second rack 11. The plastic body 17 is provided with a through hole for the penetration of the resilient body 16 on locations corresponding to each key cap 12, first rack 13 and second rack 11, and two joint holes on both side thereof and corresponding to the first rack 13 and the second rack 11.

The resilient body 16 is arranged below the first rack 13 and the second rack 11, and within the through hole of the plastic body 17. The resilient body 16 is functioned to support the first rack 13 and the second rack 11.

The flexible circuit board 14 is arranged below the plastic body 17 and has a plurality of punched holes on location corresponding to key cap 12, first rack 13 and second rack 11. Moreover, the punched holes have been applied with adhesive paste to fix above elements. The base plate 15 is placed below the flexible circuit board 14 to support the elements mounting above.

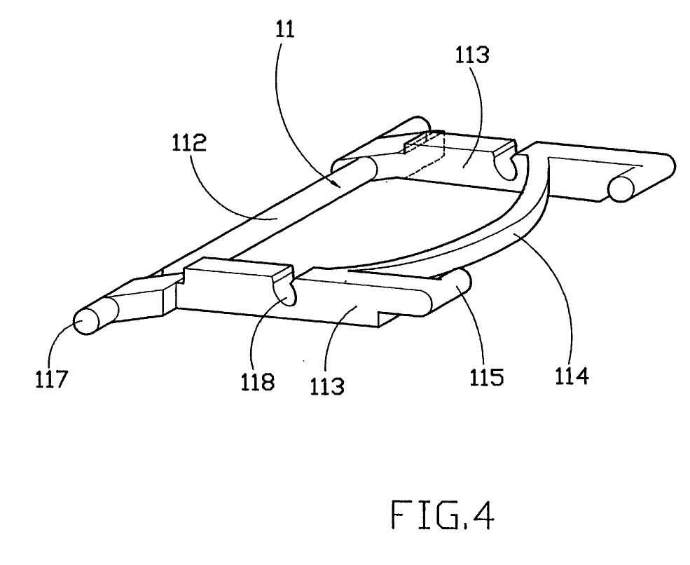

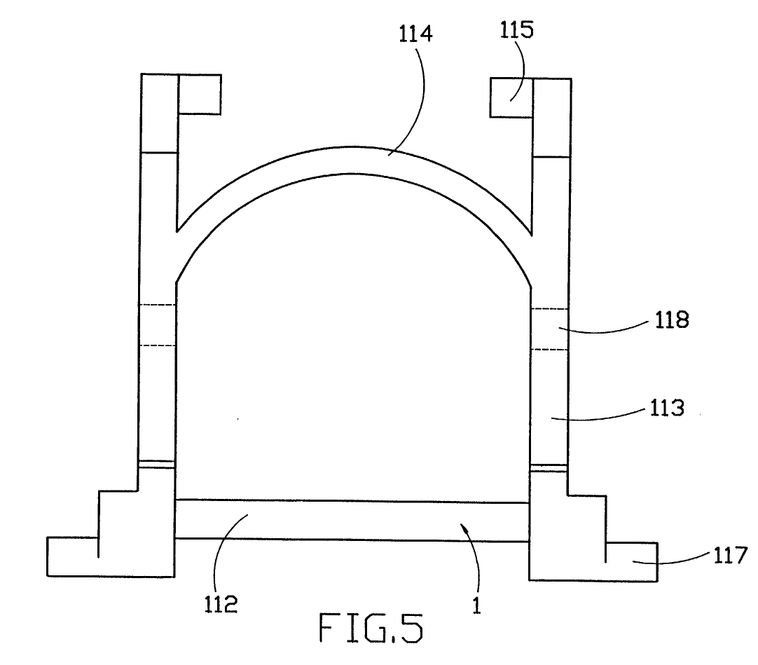

As shown in FIGS. 4-6, the second rack 11 has two opposite rack body 113, wherein one end of each rack body 113 is connected with a connection part 112 and another end of each rack body 113 is connected with an arc-shaped part 114.

The second rack 11 is arranged below the key cap 12 and has fourth shaft 115 extending from another end of the rack body 113 and corresponding to the retaining groove 123 of the key cap 12. A third shaft 117 is arranged on one end of the rack body 113 and corresponding to the join hole of the plastic body 17. The rack body 113 has an axial hole 118 corresponding to the first rack 13, the axial hole 118 has an open side.

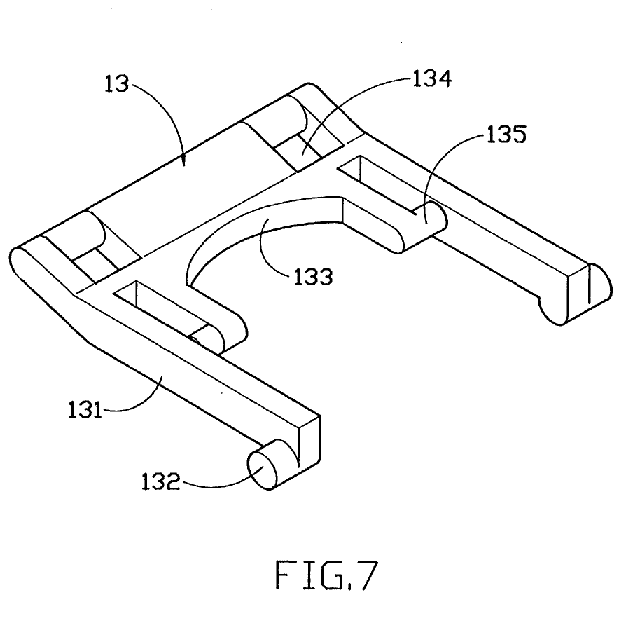

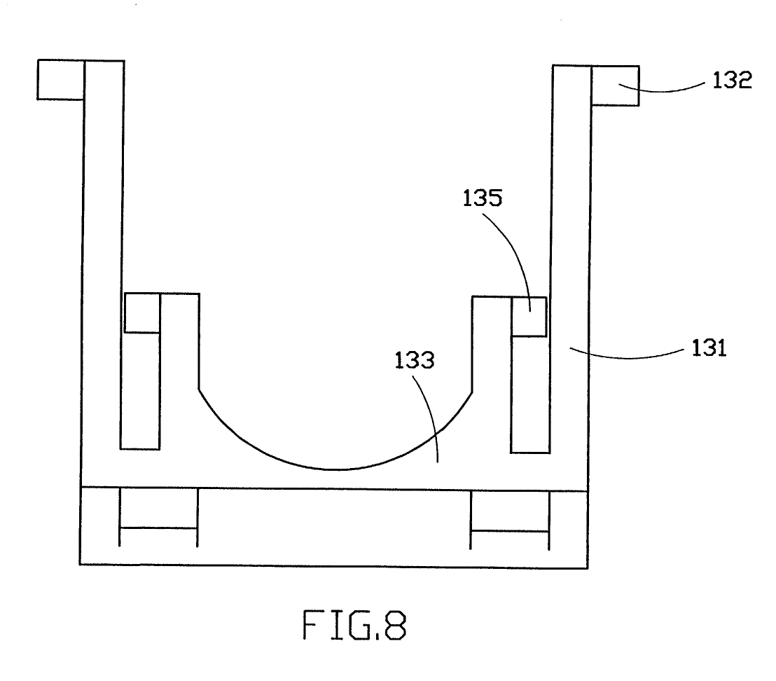

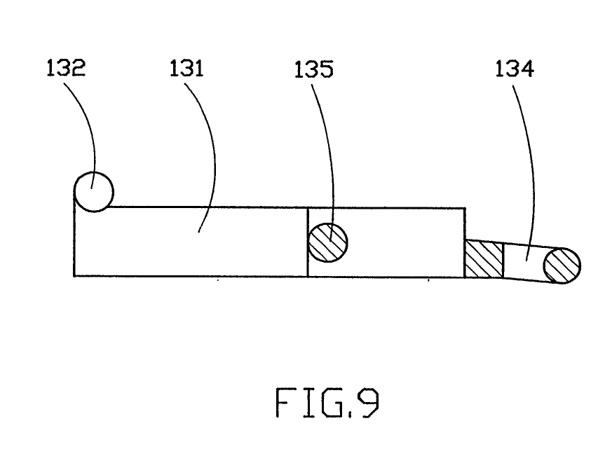

As shown in FIGS. 7-9, the first rack 13 has an inverse-U shaped rack body 131, which has a U-shaped arm portion 133 on inner side thereof. The arm portion 133 has a second shaft 135 on each lateral side, which is corresponding to the axial hole 118 of the second rack 11. Moreover, the width of the open side is smaller than the maximum width of the hole 118 such that the second shaft 135 can be easily assembled into the hole 118 and is stably retained within the hole 118 after assembling.

The first rack 13 is arranged below the key cap 12 and has a groove 134 on each end of connection side 139 of the rack body 131, which is corresponding to the embedding part 121 of the key cap 12. The rack body 131 has a first shaft 132 on each connection side 139 thereof, which is corresponding to the join hole of the plastic body 17.

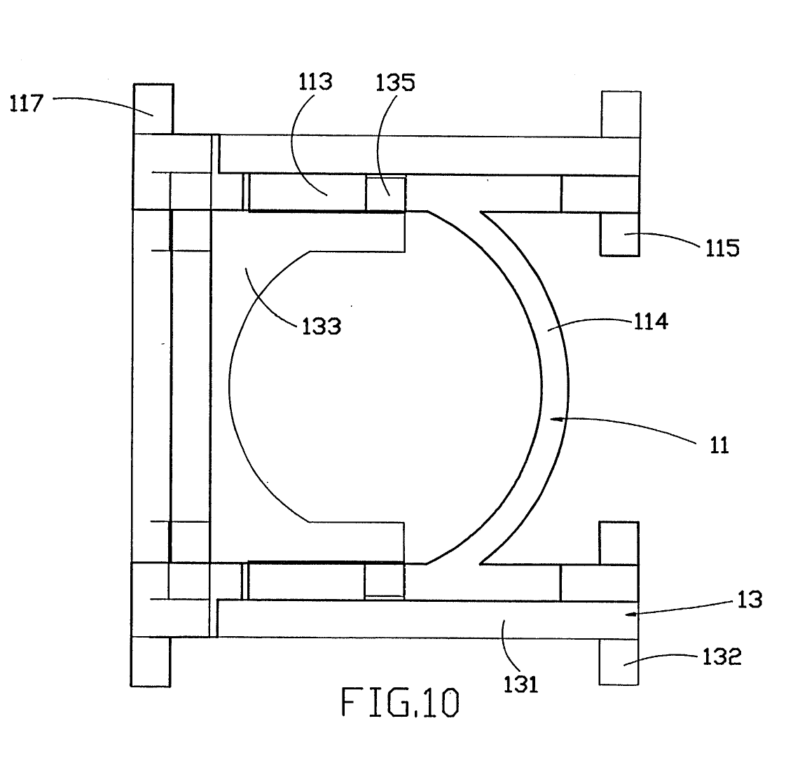

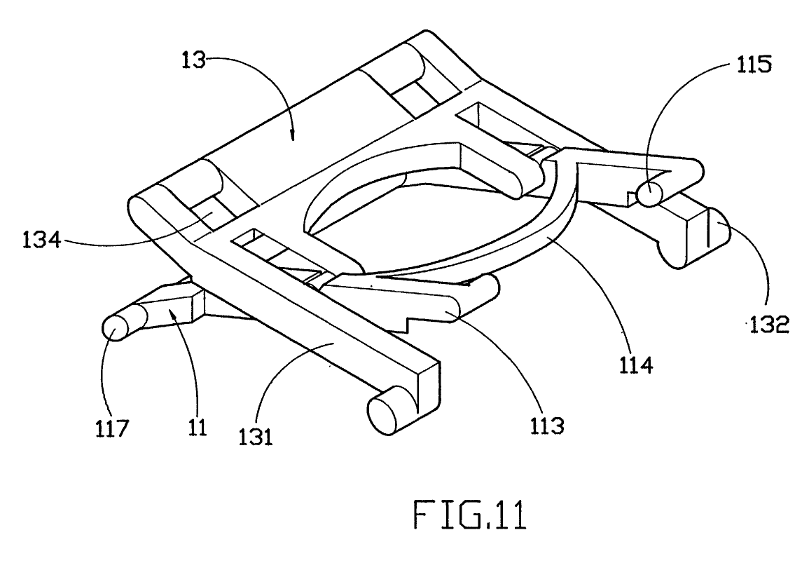

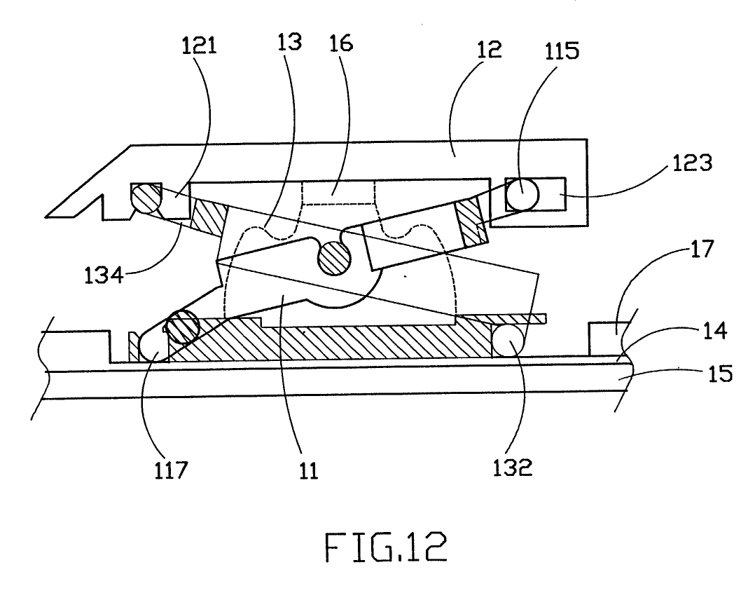

As shown in FIGS. 10 and 11, the first rack 13 has been provided with arm portion 133 on inner side thereof, therefore the contact area between the first rack 13 and second rack 11 increases. The shaky problem of the key cap 12 can be prevented, and the assembling and disassembling of the key cap 12 is easier.

By the special design of the second rack 11, that is the opening on the second rack 11 has suitable orientation such that the second rack 11 can be assembled with most ease. Moreover, the bearing of the second rack 11 is on the inner most side of the arm portion 133 of the first rack 13. The distortion or breaking of those two racks can be prevented.

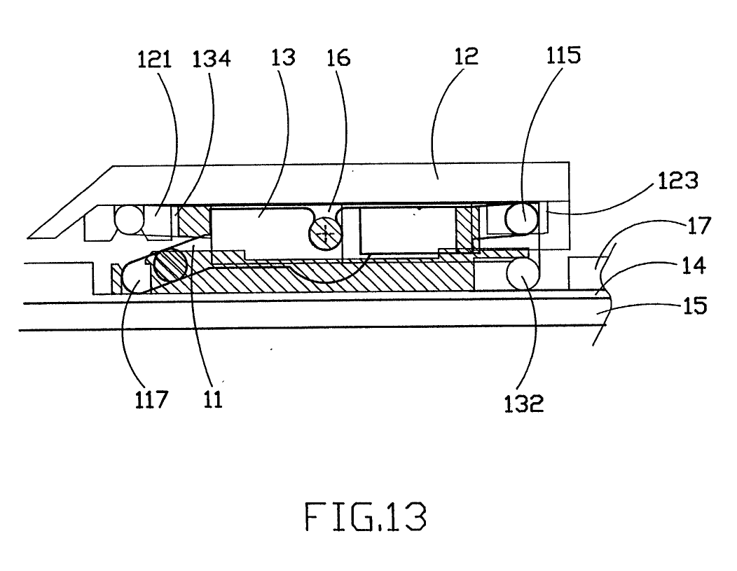

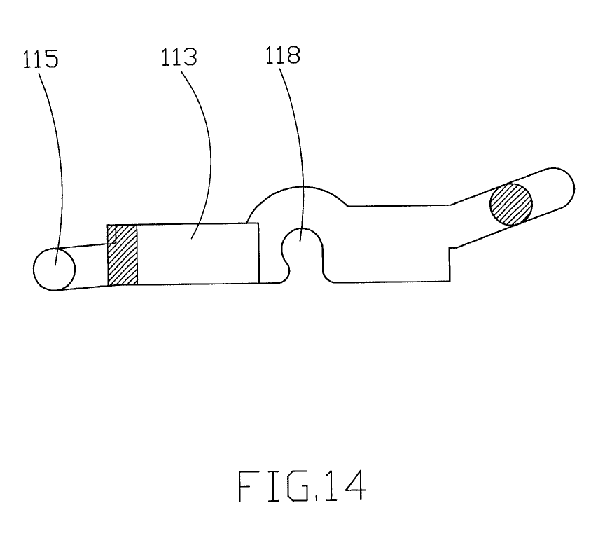

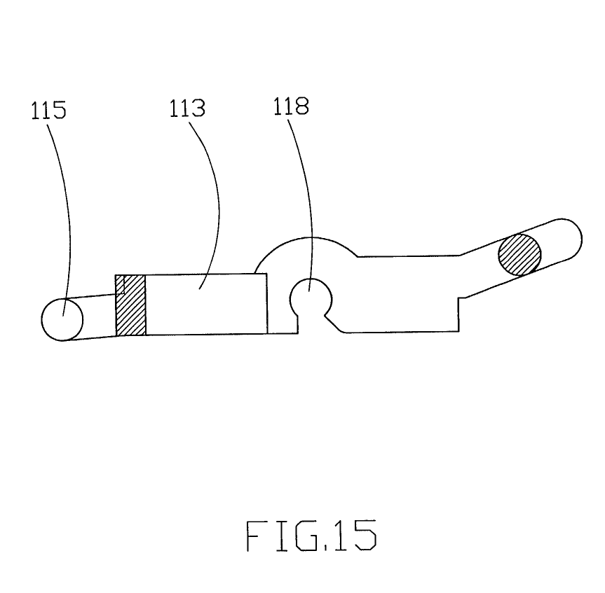

As shown in FIGS. 12 and 13, when the key cap 12 is pressed down, it will be guided by the first rack 13 and the second rack 11 to move downward in vertical direction. The key cap 12 will lead the resilient body 16 to press on the flexible circuit board 14, thus turning on the keying as shown in FIG. 13. Moreover, if the force acting on the key cap 12 is released, the key cap 12 will be moved upward by the resilient force of the resilient body 16 and guided by the two rack 11 and 13. The resilient body will be detached from the flexible circuit board 14, thus turning off the keying, as shown in FIG. 12.

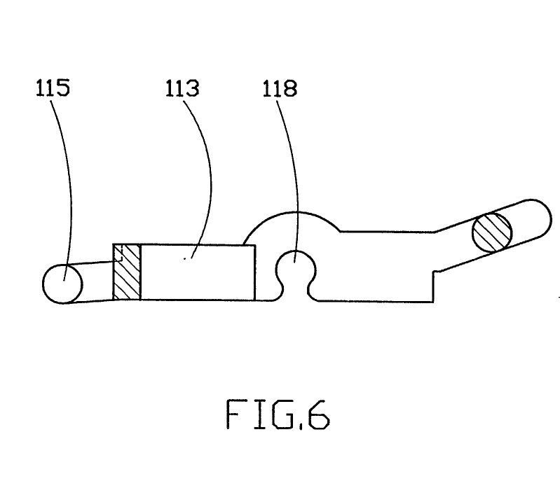

Moreover, as shown in FIGS. 14 and 15, the shape of the hole 18 is not symmetric such that the shaft 135 has better performance in assembling and retaining in the hole 18 in comparison with the case shown in FIG. 6. As shown in FIG. 15, the hole 18 has a bevel surface near the open side for facilitating automatic production.

To sum up, the inventive support linkage for keyswitch can solve the assembling and poor strength problems of the conventional keyset of notebook computer; therefore it is of industrial interest.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A support linkage movably connecting a key cap to a plastic body comprising:
(a) a first rack, said first rack having (a) a first rack body movably connected between the key cap and the plastic body, said first rack body having a pair of first arms extending therefrom for pivotally coupling with the plastic body, and (b) an arm portion having a pair of second arms extending therefrom and respectively spaced from said pair of first arms, each of said second arms having a shaft extending from a side thereof; and,
a second rack having a second rack body movably connected between the key cap and the plastic body, said second rack body having a pair of third arms extending therefrom, each of the third arms being disposed between a respective first and second arm and having an axial hole formed therein; the axial hole having an open side for receiving said shaft of said second arm such that the said shaft is engaged into the axial hole;
whereby said first rack and said second rack are pivotally connected together.

2. The support linkage movably connecting a key cap to a plastic body as in claim 1, wherein the width of the open side is smaller than maximum width of the axial hole.

3. The support linkage movably connecting a key cap to a plastic body as in claim 1, wherein the shape of the hole is not symmetric.

4. The support linkage movably connecting a key cap to a plastic body as in claim 1, wherein the hole has a bevel surface near the open side.
